(19) United States
(12) Patent Application Publication
(10) Pub. No.: US 2026/0331353 A1
(43) Pub. Date: Oct. 22, 2026

(54) COIL DEVICE

(71) Applicant: TDK Corporation, Tokyo (JP)

(72) Inventors: Kyosuke INUI, Tokyo (JP); Ryuji ANDO, Tokyo (JP); Masashi GOTOH, Tokyo (JP); Toru KADOI, Tokyo (JP)

(73) Assignee: TDK Corporation, Tokyo (JP)

(21) Appl. No.: 19/565,127

(22) Filed: Mar. 12, 2026

(30) Foreign Application Priority Data
Mar. 13, 2025 (JP) 2025-040637

(51) Int. Cl. H01F 27/255; H01F 27/30

(52) U.S. Cl. CPC H01F 27/255; H01F 27/306

(57) ABSTRACT

A coil device includes a coil; a core including a base portion, the coil being placed on the base portion; and an exterior body covering the coil and at least an upper part of the base portion, the upper part being above a bottom surface of the base portion. The exterior body includes metal particles. The base portion has a notch at a corner. The exterior body includes a bottom corner portion covering the notch and an upper corner portion located above the notch. The metal particles occupying the bottom corner portion account for a volume fraction not smaller than that of the metal particles occupying the upper corner portion.

The present application claims a priority to Japanese patent application No. 2025-040637 filed on Mar. 13, 2025, which is incorporated herein by reference in its entirety.

### BACKGROUND OF THE INVENTION

The present disclosure relates to a coil device.

Conventionally known is a coil device including an exterior body and a coil disposed in the exterior body (Patent Document 1). Such a coil device is formed by attaching the coil to a base of a sintered core and covering them with the exterior body including a resin.

However, the core, which is supposed to be covered with the exterior body, of such a coil device may unfortunately become exposed from the exterior body through a manufacturing process. In such a situation, the core may crack or the exterior body may fall off, which may lead to a reduction in quality (e.g., characteristic degradation).

[Patent Document 1] JP Patent Application Laid Open No. 2020-77790

### BRIEF SUMMARY OF THE INVENTION

The present inventors have focused on the fact that a base-side corner of a core of a conventional coil device easily becomes exposed from an exterior body due to poor filling of the exterior body, having completed the present disclosure.

A coil device according to one aspect of the present disclosure includes a coil;
a core including a base portion, the coil being placed on the base portion; and
an exterior body covering the coil and at least an upper part of the base portion, the upper part being above a bottom surface of the base portion,
wherein
the exterior body includes metal particles,
the base portion has a notch at a corner,
the exterior body includes a bottom corner portion covering the notch and an upper corner portion located above the notch, and
the metal particles occupying the bottom corner portion account for a volume fraction not smaller than that of the metal particles occupying the upper corner portion.

### BRIEF DESCRIPTION OF DRAWINGS

FIG. 1A is an overall perspective view of a coil device according to one embodiment.

FIG. 1B is an overall perspective view of the coil device illustrated in FIG. 1A viewed from a different angle.

FIG. 2A is a sectional view along a line IIA-IIA illustrated in FIG. 1A.

FIG. 2B is a sectional view along a line IIB-IIB illustrated in FIG. 1A.

FIG. 2C is a sectional view along a line IIC-IIC illustrated in FIG. 1A.

FIG. 2D is a sectional view along a line IID-IID illustrated in FIG. 1A.

FIG. 3A is an enlarged sectional view of a part IIIA illustrated in FIG. 2C.

FIG. 3B is an enlarged sectional view of a part IIIB illustrated in FIG. 2C.

FIG. 3C is an enlarged sectional view of a part IIIC illustrated in FIG. 2C.

FIG. 4 is a partial perspective view of a structure of the coil device illustrated in FIG. 1A.

FIG. 5A is a bottom plan view of the coil device illustrated in FIG. 1A with terminal electrodes being omitted.

FIG. 5B is a bottom plan view of a coil device according to another embodiment with terminal electrodes being omitted.

FIG. 5C is a bottom plan view of a coil device according to still another embodiment with terminal electrodes being omitted.

FIG. 5D is a bottom plan view of a coil device according to still another embodiment with terminal electrodes being omitted.

### DETAILED DESCRIPTION OF THE INVENTION

Hereinafter, embodiments of the present disclosure are described with reference to the drawings. Illustrations in the drawings are only schematically and exemplarily provided for understanding of the present disclosure; and the illustrated appearance, dimensional ratios, or the like may differ from those of an actual device. The present disclosure is not construed as limited to the following embodiments.

In the present disclosure, “identical,” “same,” “equivalent,” or “similar” is not a concept encompassing only a state where the physical quantities of compared objects are strictly identical, the same, equivalent to each other, or similar; and the concept of “identical,” “same,” “equivalent,” or “similar” encompasses a state with a discrepancy of ±Δ % or less (not limited; e.g., Δ=7, 5, or 3) between the physical quantities of the compared objects.

In the present disclosure, “parallel” is not a concept encompassing only a strictly parallel state; and the concept of “parallel” encompasses a state with a discrepancy of ±Δθ° or less (not limited; e.g., Δθ=3) relative to the strictly parallel state. Likewise, “perpendicular” or “orthogonal” is not a concept encompassing only a strictly perpendicular or orthogonal state; and the concept of “perpendicular” or “orthogonal” encompasses a state with a discrepancy of ±Δθ° or less (not limited; e.g., Δθ=3) relative to the strictly perpendicular or orthogonal state.

### First Embodiment

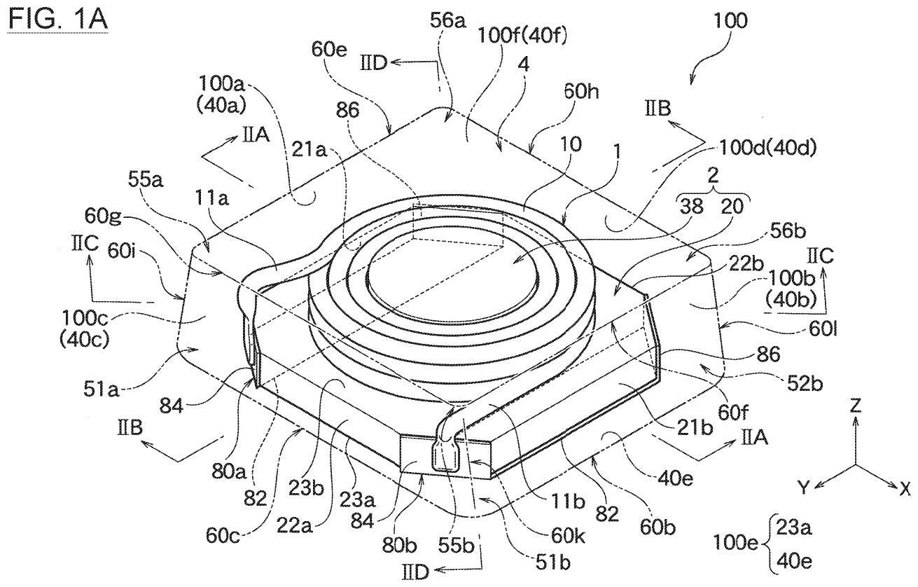

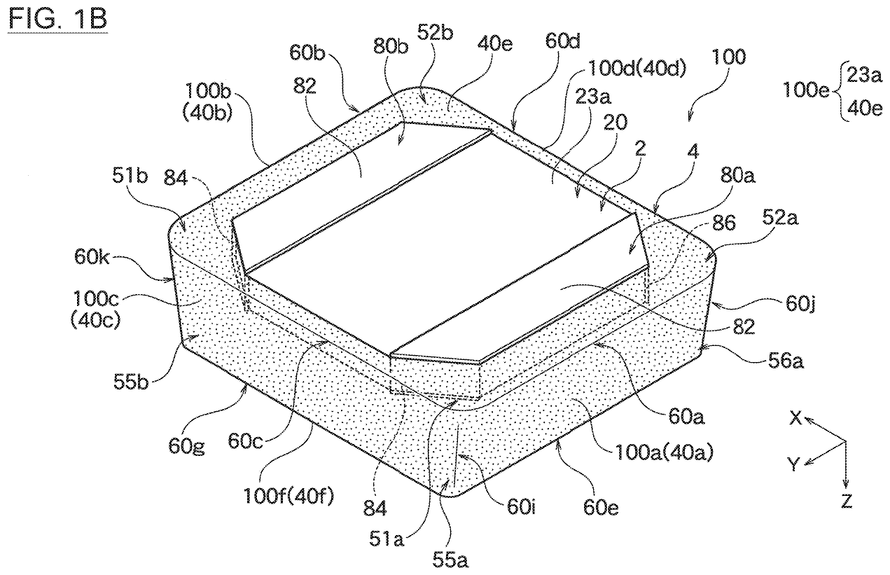

A coil device 100 of a first embodiment illustrated in FIG. 1A functions as, for example, an inductor and is mounted on a power supply or the like of various electronics. The coil device 100 includes a coil 1, a core 2, an exterior body 4, and terminal electrodes 80a and 80b. The coil device 100 is a surface-mounting coil device. The coil 1 is wound around a core central portion 38 of the core 2 and is placed above a base portion 20 of the core 2 in the Z-axis direction. The exterior body 4 covers the coil 1 and an upper part of the base portion 20, which is above a bottom surface 23a of the base portion 20.

In the coil device 100, the core 2 and the exterior body 4 integrally constitute what is commonly referred to as an element body of the coil device 100. In the following description of the present embodiment, to simplify illustration, the core 2 is defined as including the core central portion 38 and the base portion 20 whereas the exterior body 4 is defined as being a member separate from the core 2 and covering the coil 1 together with the core 2, as described above.

The element body of the coil device 100 has a substantially hexahedral shape. In the drawings, the X-axis is an axis corresponding to a direction in which a first surface 100a and a second surface 100b of the element body face each other. The Y-axis is an axis corresponding to a direction in which a third surface 100c and a fourth surface 100d of the element body face each other. The Z-axis is an axis perpendicular to the X-axis and the Y-axis, corresponding to a direction in which a fifth surface 100e and a sixth surface 100f of the element body face each other. In the following description, with regard to the X-axis, the Y-axis, and the Z-axis, a direction or a side away from a center of the element body is referred to as an outward direction or an outer side whereas a direction or a side toward the center of the element body is referred to as an inward direction or an inner side. A positive direction of the Z-axis (a direction toward the sixth surface 100f from the fifth surface 100e) or a side in that direction is referred to as an upward direction or an upper side whereas a negative direction of the Z-axis (a direction toward the bottom surface 23a from the sixth surface 100f) or a side in that direction is referred to as a downward direction or a lower side. However, the upper side in the Z-axis direction does not necessarily match a vertically upper side. Likewise, the lower side in the Z-axis direction does not necessarily match a vertically lower side.

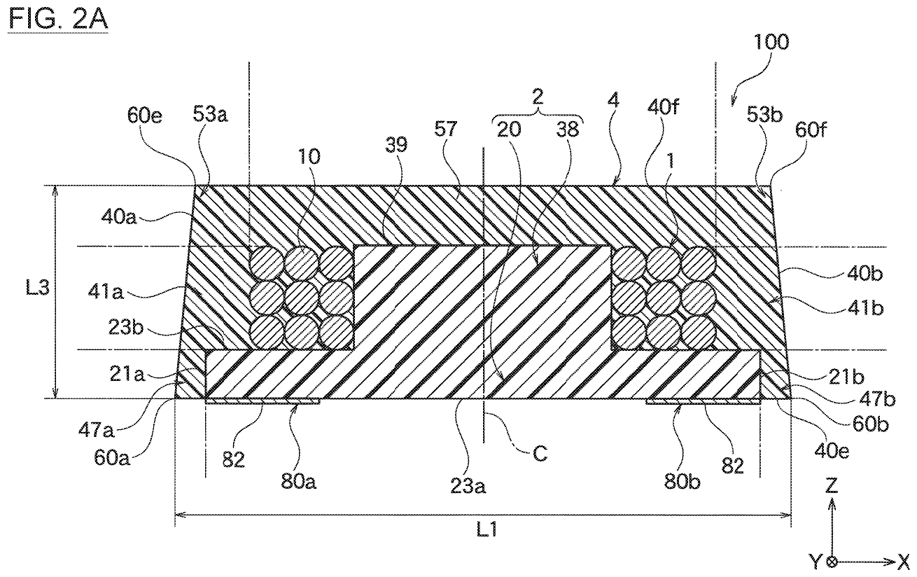

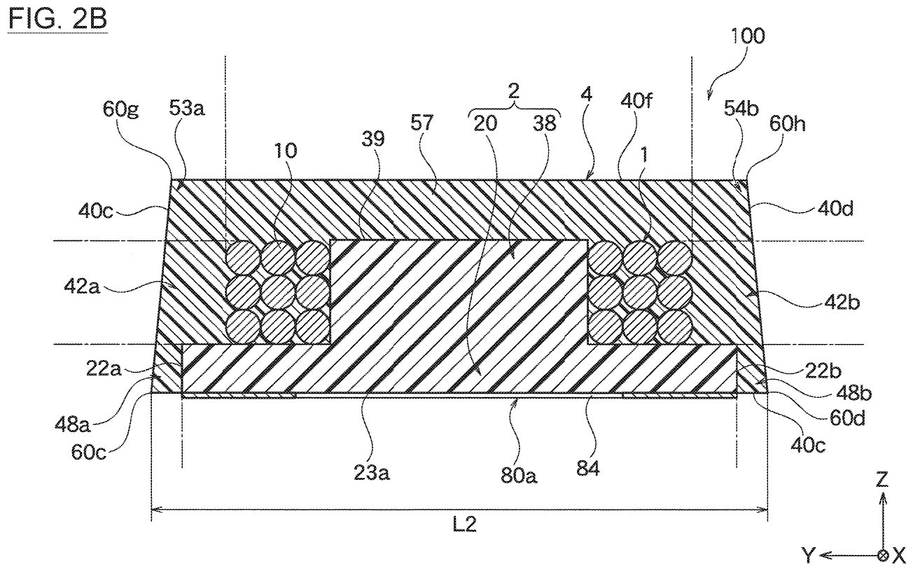

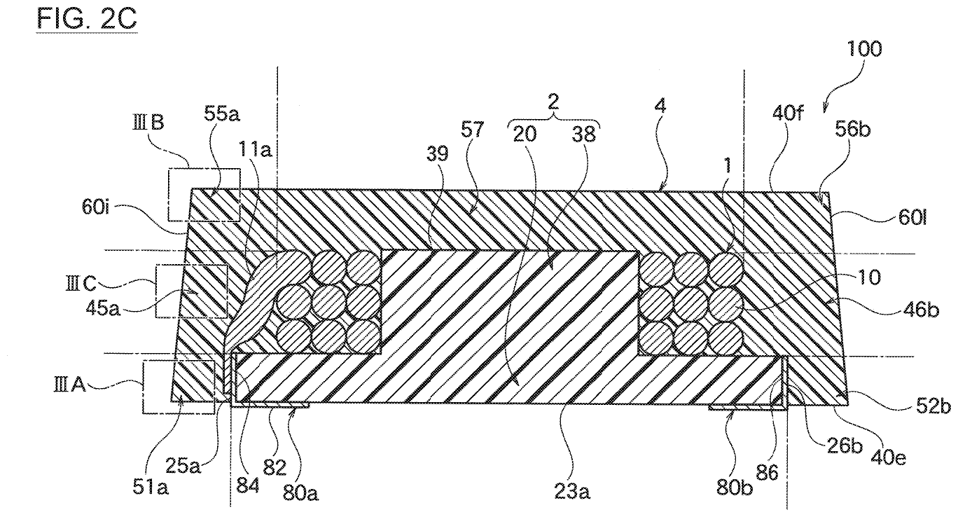

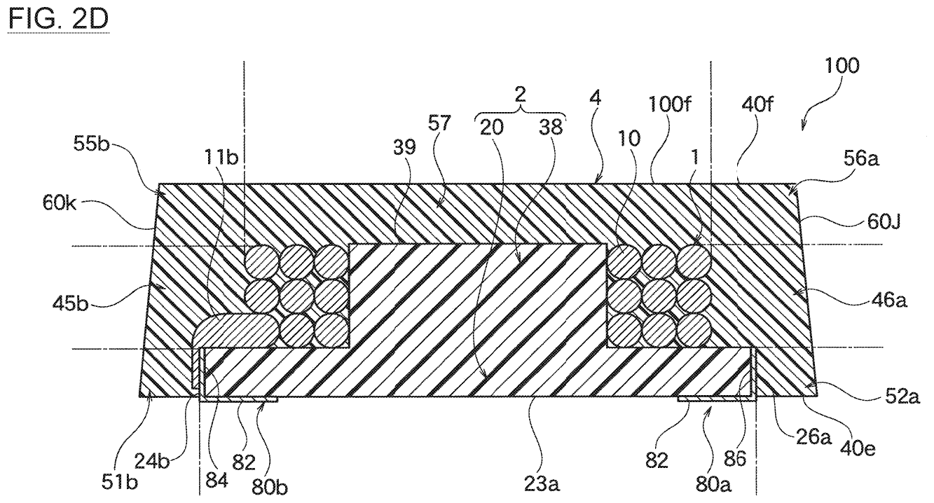

The exterior body 4 may have any length L1 in the X-axis direction (see FIG. 2A). This length is, for example, 0.6 to 6.5 mm. The exterior body 4 may have any length L2 in the Y-axis direction (see FIG. 2B). This length is, for example, 0.6 to 6.5 mm. The exterior body 4 may have any length L3 in the Z-axis direction (see FIG. 2A). This length is, for example, 0.5 to 5.0 mm.

As illustrated in FIG. 1B, the first surface 100a of the element body constitutes a first surface 40a of the exterior body 4. The second surface 100b of the element body constitutes a second surface 40b of the exterior body 4. The third surface 100c of the element body constitutes a third surface 40c of the exterior body 4. The fourth surface 100d of the element body constitutes a fourth surface 40d of the exterior body 4. The sixth surface 100f of the element body constitutes a sixth surface 40f of the exterior body 4.

In contrast, the fifth surface 100e of the element body constitutes the bottom surface 23a of the base portion 20 of the core 2 and a fifth surface 40e of the exterior body 4, which is located around the bottom surface 23a. The fifth surface 100e constitutes a mounting surface of the coil device 100. The mounting surface is a surface that opposes a wiring substrate (not illustrated in the drawings) when the coil device 100 is mounted on the wiring substrate.

As illustrated in FIG. 1B, the first surface 100a, the second surface 100b, the third surface 100c, and the fourth surface 100d are inclined surfaces meeting the fifth surface 100e at an acute angle. The sloping angle 01 of the first surface 100 a relative to the fifth surface 100 e is not limited but is, for example, 60°≤01 <90°. This sloping angle 01 may be, for example, 75°≤01 ≤85°. However, it may be that the first surface 100 a is not an inclined surface, and the sloping angle θ1 of the first surface 100 a relative to the fifth surface 100 e may be 90°. The same applies to the sloping angle θ2 of the second surface 100 b relative to the fifth surface 100 e, the sloping angle θ3 of the third surface 100 c relative to the fifth surface 100 e, and the sloping angle θ4 of the fourth surface 100 d relative to the fifth surface 100 e. Note that all of the sloping angles θ1, θ2, θ3, and θ4 may be identical or may be different.

Inclination of at least one of the first surface 100a, the second surface 100b, the third surface 100c, and the fourth surface 100d enables the orientation of the exterior body 4 to be identified from its external shape. Inclination of at least one of the first surface 100a, the second surface 100b, the third surface 100c, and the fourth surface 100d also enables the exterior body 4 to have a smaller size.

Structures of portions of the coil device 100 are described below.

As illustrated in FIG. 1A, the coil 1 includes a winding portion 10, which is wound in a coil shape, and lead-out portions 11a and 11b in pairs, which are led out from the winding portion 10. The winding portion 10 is located in the exterior body 4 and is provided around an outer circumferential surface of the core central portion 38 of the core 2. The winding portion 10 of the coil 1 may be provided by, for example, winding a wire around the core central portion 38 of the core 2. The winding portion 10 of the coil 1 may be provided also as an air core coil; and such a winding portion 10 may be fitted to the core central portion 38 of the core 2.

As the wire constituting the coil 1, a conductive core wire (e.g., a rectangular wire, a round wire, a stranded wire, a litz wire, or a braided wire) made from Cu, Al, Fe, Ag, Au, phosphor bronze, or the like or an insulation coated wire including such a conductive core wire covered with an insulating film can be used. Specifically, a known wire such as a polyamide-imide enameled wire (AIW), a polyurethane enameled wire (UEW), or USTC can be used. The wire may have any diameter. In a situation where the wire is a round wire, the diameter is, for example, 50 μm to 2 mm. In a situation where the wire is a rectangular wire, the wire has, for example, a thickness of 20 μm to 2 mm and a width of 40 μm to 2 mm.

As illustrated in FIG. 2A, the number of layers of the winding portion 10 in its winding axis direction is, for example, three; and the number of layers in the radial direction is, for example, three. The winding axis direction of the winding portion 10 corresponds to the Z-axis direction, i.e., the direction perpendicular to the fifth surface 100e of the element body of the coil device 100.

As illustrated in FIG. 1A, the lead-out portions 11a and 11b constitute one end and an other end of the wire constituting the coil 1, respectively, and are disposed apart in the X-axis direction. The lead-out portion 11a is led out toward the third surface 100c of the element body from one end of the winding portion 10 in the Z-axis direction, inside the exterior body 4. The lead-out portion 11a is connected to the terminal electrode 80a using, for example, thermocompression bonding, soldering, or a conductive adhesive.

Likewise, the lead-out portion 11b is led out toward the third surface 100c of the element body from an other end of the winding portion 10 in the Z-axis direction, inside the exterior body 4. The lead-out portion 11b is connected to the terminal electrode 80b using, for example, thermocompression bonding, soldering, or a conductive adhesive.

The terminal electrodes 80a and 80b are provided at the base portion 20 and are disposed apart along the X-axis. The terminal electrodes 80a and 80b each have a thickness of, for example, 3 μm to 100 μm. The thickness of the terminal electrode 80 a is identical to the thickness of the terminal electrode 80b but may differ from the thickness of the terminal electrode 80b.

The terminal electrodes 80a and 80b each constitute a multilayer electrode film including, for example, a base electrode film and a plating film provided on the base electrode film. The base electrode film is not limited and is, for example, a conductive paste film containing a metal such as Sn, Ag, Ni, Cu, Pd, or the like or their alloy. The plating film is not limited and is, for example, a metal such as Sn, Au, Ni, Pt, Ag, Pd, Cu, or the like or their alloy.

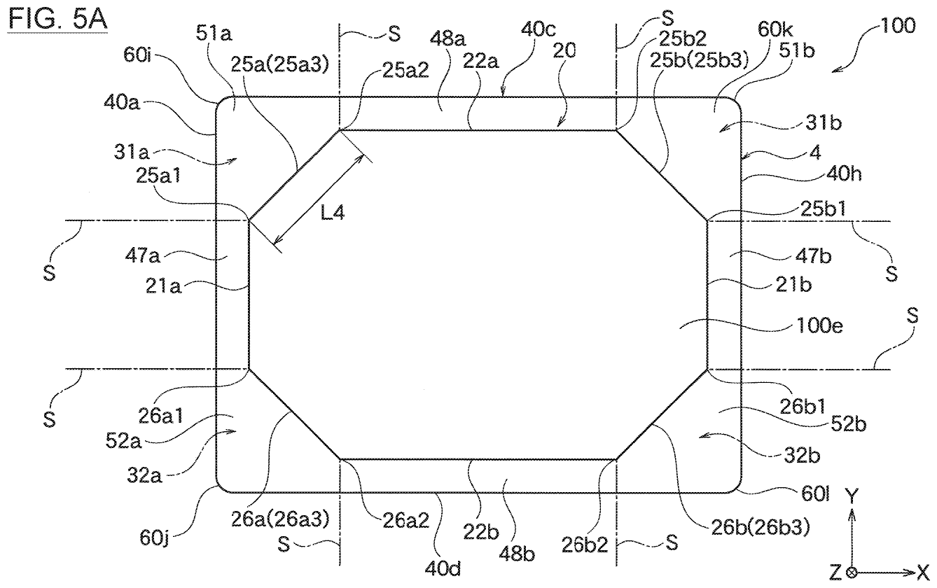

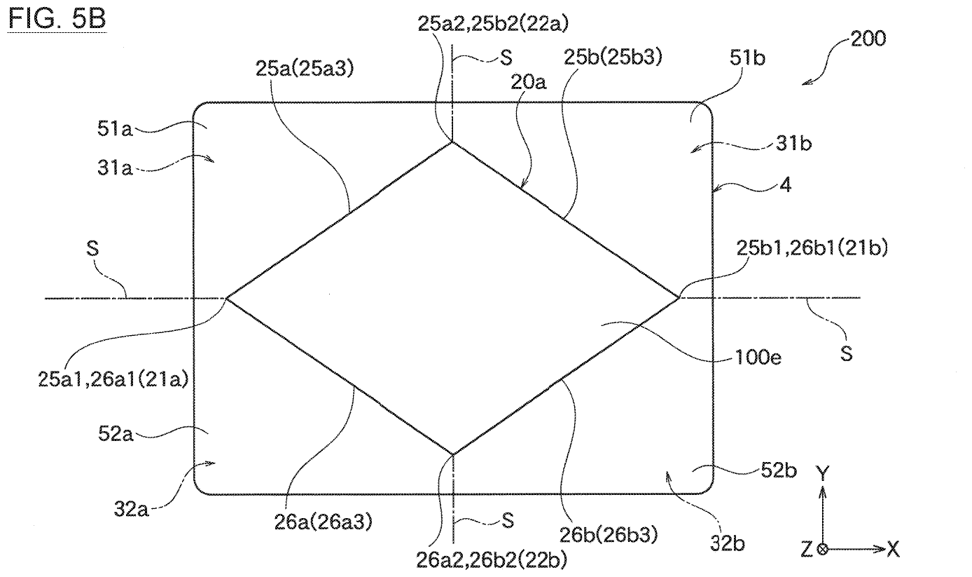

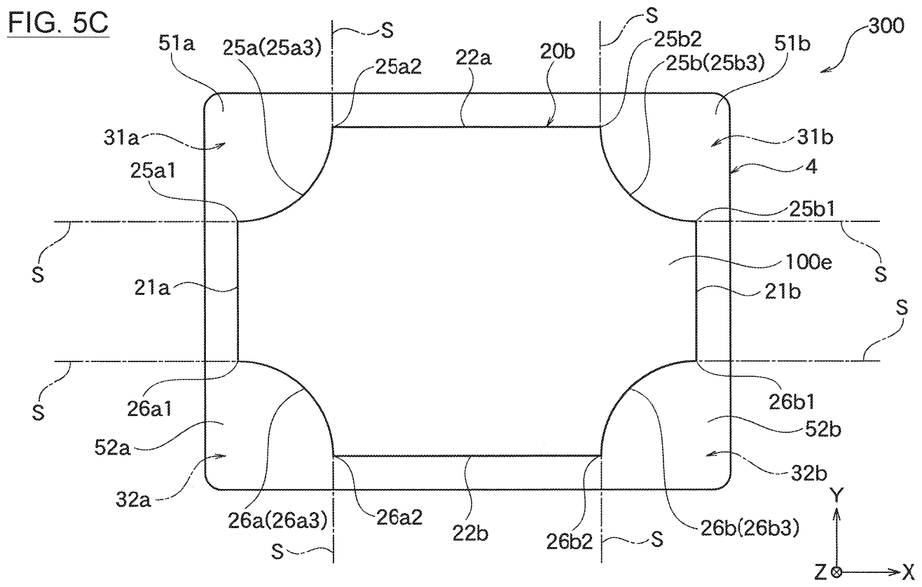

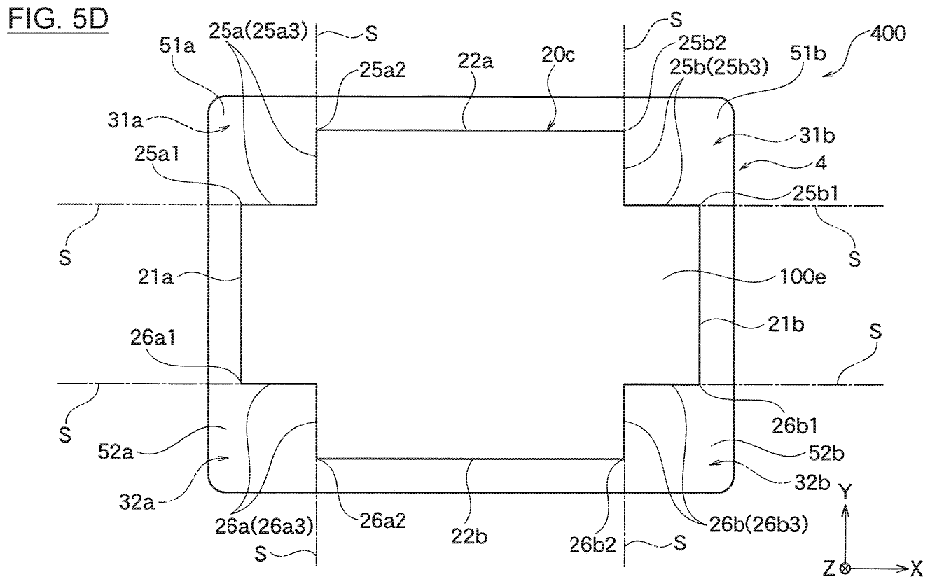

The terminal electrodes 80a and 80b include mounting portions 82 and 82, respectively. The mounting portions 82 and 82 are disposed at the bottom surface 23a of the base portion 20, are exposed from the core 2 and the exterior body 4, and extend along the Y-axis. In other words, the terminal electrodes 80a and 80b include the mounting portions 82 and 82, which are attached to the fifth surface 100e of the element body. The mounting portions 82 and 82 may have any shape. This shape is, for example, a trapezoid (see FIG. 5A) in plan view from the winding axis direction (Z-axis direction).

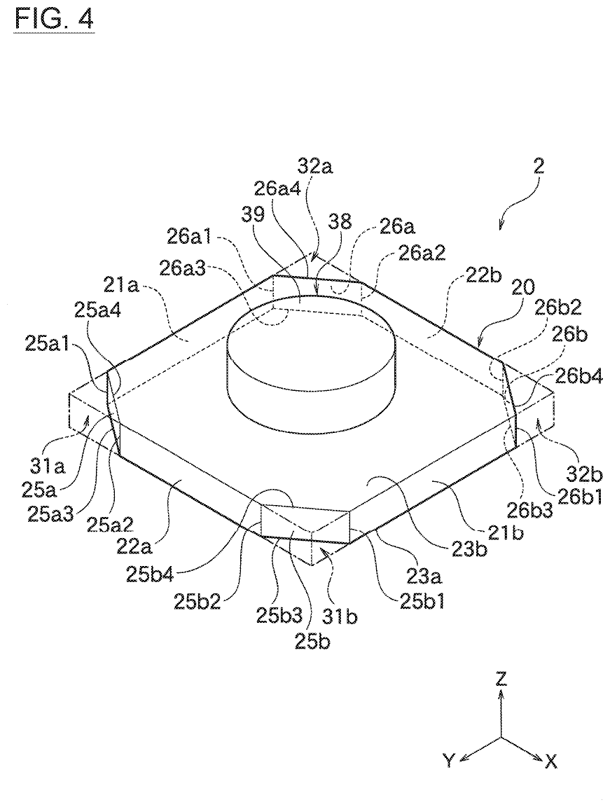

As illustrated in FIGS. 1A and 1B, the terminal electrodes 80a and 80b include wire connecting portions 84 and 84, respectively. The wire connecting portions 84 and 84 are disposed at meeting surfaces 25a and 25b (see FIG. 4) of the base portion 20 described later and extend upward in the Z-axis direction from one longitudinal end of the mounting portion 82 and one longitudinal end of the other mounting portion 82. To the wire connecting portion 84 of the terminal electrode 80a, the lead-out portion 11a is connected. To the wire connecting portion 84 of the terminal electrode 80b, the lead-out portion 11b is connected. The wire connecting portions 84 and 84 are covered with the core 2 and the exterior body 4. In other words, the wire connecting portions 84 are embedded in the element body.

The terminal electrodes 80a and 80b include dummy wire connecting portions 86 and 86, respectively. The dummy wire connecting portions 86 and 86 are disposed at meeting surfaces 26a and 26b (see FIG. 4) of the base portion 20 described later and extend upward in the Z-axis direction from an other longitudinal end of the mounting portion 82 and an other longitudinal end of the other mounting portion 82. The dummy wire connecting portions 86 and 86 are covered with the core 2 and the exterior body 4. In other words, the dummy wire connecting portions 86 are embedded in the element body. Note that, in the present embodiment, it may be that no dummy wire connecting portions 86 and 86 are provided and that the other longitudinal ends of the mounting portions 82 and 82 are located at the bottom surface 23a of the base portion 20.

As illustrated in FIG. 4, the core 2 is a T-shaped core including the core central portion 38 and the base portion 20. Although the core 2 of the present embodiment is a sintered body of a metal magnetic body, the core 2 is not limited thereto. The core 2 may be, for example, a metal core that results from annealing a molded body provided through compaction molding, injection molding, machining, or the like. Alternatively, the core 2 may be, for example, a sintered body of a magnetic body that results from sintering a molded body provided through compaction molding, injection molding, machining, or the like of ceramics material (e.g., ferrites). Alternatively, the core 2 may be a composite core that results from molding a resin including magnetic particles. The core 2 may be made from a material having a larger relative permeability than that of metal particles included in the exterior body 4 described later but may be made from the same material as that of the exterior body 4.

As illustrated in FIG. 1A, the coil 1 is disposed around the core central portion 38 of the core 2. The bottom surface 23a of the base portion 20 of the core 2 is exposed to the mounting surface of the coil device 100 and constitutes the fifth surface 100e of the element body. Portions of the core 2 other than the bottom surface 23a are disposed in the exterior body 4. That is, the core 2, together with the coil 1, is substantially entirely covered with the exterior body 4.

As illustrated in FIG. 4, the core central portion 38 has a substantially cylindrical shape. As illustrated in FIG. 2A, the core central portion 38, at a central part of the base portion 20, protrudes upward in the Z-axis direction along a central axis C from an upper surface 23b of the base portion 20. A protruding end 39 of the core central portion 38, which is opposite from the base portion 20, is covered with the exterior body 4.

The core central portion 38 may have any protruding height from the upper surface 23b of the base portion 20 to the protruding end 39. This height can be about 20% to about 60% of the entire thickness L3 of the coil device 100. The protruding height of the core central portion 38, in the present embodiment, is about the same as the thickness of the winding portion 10 in the Z-axis direction but may be larger or smaller than the thickness of the winding portion 10 in the Z-axis direction. The shape of the core central portion 38 is not limited to the cylindrical shape and may be, for example, a quadrangular prism, an octagonal prism, or other polygonal prism. Also, in the present embodiment, the core central portion 38 may protrude at a location radially offset from the central part of the base portion 20.

As illustrated in FIG. 4, the base portion 20 includes the bottom surface 23a at the lower side in the Z-axis direction and the upper surface 23b at the upper side in the Z-axis direction, having a flat plate shape. The base portion 20 includes side surfaces 21a and 21b, which couple the bottom surface 23a and the upper surface 23b, and end surfaces 22a and 22b, which couple the bottom surface 23a and the upper surface 23b.

The side surface 21a is located at one end in the X-axis direction. The side surface 21b is located at an other end in the X-axis direction. The end surface 22a is located at one end in the Y-axis direction. The end surface 22b is located at an other end in the Y-axis direction. In the present embodiment, the side surfaces 21a and 21b are perpendicular to the X-axis; the end surfaces 22a and 22b are perpendicular to the Y-axis; and the bottom surface 23a and the upper surface 23b are perpendicular to the Z-axis. Note that the side surfaces 21a and 21b and the end surfaces 22a and 22b may be inclined relative to the X-axis and the Y-axis.

As illustrated in FIG. 4, corners 31a, 31b, 32a, and 32b of the base portion 20 are notched. In detail, as illustrated in FIG. 5A, the bottom surface 23a of the base portion 20 has an external shape that is similar to that of the exterior body 4 in plan view but is notched at the corners 31a, 31b, 32a, and 32b.

Note that, in the present specification, a corner of the base portion 20 indicates where a side surface and an end surface of the base portion 20 are coupled. That is, in the present embodiment, the corner 31a, where the side surface 21a and the end surface 22a meet; the corner 31b, where the side surface 21b and the end surface 22a meet; the corner 32a, where the side surface 21a and the end surface 22b meet; and the corner 32b, where the side surface 21b and the end surface 22b meet, are notched. In other words, the base portion 20 has notches at the respective four corners where the side surfaces and the end surfaces are coupled.

As illustrated in FIG. 4, the notch corresponding to the corner 31a has the meeting surface 25a. The meeting surface 25a is coupled to the side surface 21a, the end surface 22a, the bottom surface 23a, and the upper surface 23b. The meeting surface 25a meets the side surface 21a and the end surface 22a at an obtuse angle and meets the bottom surface 23a and the upper surface 23b perpendicularly.

A side-surface edge portion 25a1, where the meeting surface 25a is coupled to the side surface 21a, is parallel to the Z-axis. An end-surface edge portion 25a2, where the meeting surface 25a is coupled to the end surface 22a, is parallel to the Z-axis. A bottom edge portion 25a3, where the meeting surface 25a is coupled to the bottom surface 23a, is perpendicular to the Z-axis. An upper edge portion 25a4, where the meeting surface 25a is coupled to the upper surface 23b, is perpendicular to the Z-axis.

Where a plane on which the meeting surface 25a lies meets a plane on which the side surface 21a, the end surface 22a, the bottom surface 23a, or the upper surface 23b lies may be deemed to be the edge portions of these surfaces. The side-surface edge portion 25al, the end-surface edge portion 25a2, the bottom edge portion 25a3, and the upper edge portion 25a4 may be edgy or may be smoothly chamfered or rounded. The distance L4 between the side-surface edge portion 25al and the end-surface edge portion 25a2 illustrated in FIG. 5A is not limited but may be 1/10 or more and ½ or less or ⅕ or more and ⅓ or less of the length L1 (see FIG. 2A) of the element body in the X-axis direction.

As illustrated in FIG. 4, the notch corresponding to the corner 31b has the meeting surface 25b. The meeting surface 25b is coupled to the side surface 21b, the end surface 22a, the bottom surface 23a, and the upper surface 23b. The meeting surface 25b meets the side surface 21b and the end surface 22a at an obtuse angle and meets the bottom surface 23a and the upper surface 23b perpendicularly.

A side-surface edge portion 25b1, where the meeting surface 25b is coupled to the side surface 21b, is parallel to the Z-axis. An end-surface edge portion 25b2, where the meeting surface 25b is coupled to the end surface 22a, is parallel to the Z-axis. A bottom edge portion 25b3, where the meeting surface 25b is coupled to the bottom surface 23a, is perpendicular to the Z-axis. An upper edge portion 25b4, where the meeting surface 25b is coupled to the upper surface 23b, is perpendicular to the Z-axis.

Where a plane on which the meeting surface 25b lies meets a plane on which the side surface 21b, the end surface 22a, the bottom surface 23a, or the upper surface 23b lies may be deemed to be the edge portions of these surfaces. The side-surface edge portion 25b1, the end-surface edge portion 25b2, the bottom edge portion 25b3, and the upper edge portion 25b4 may be edgy or may be smooth. The distance between the side-surface edge portion 25b1 and the end-surface edge portion 25b2 may be similar to the distance LA (see FIG. 5A) between the side-surface edge portion 25al and the end-surface edge portion 25a2.

As illustrated in FIG. 4, the notch corresponding to the corner 32a has the meeting surface 26a. The meeting surface 26a is coupled to the side surface 21a, the end surface 22b, the bottom surface 23a, and the upper surface 23b. The meeting surface 26a meets the side surface 21a and the end surface 22b at an obtuse angle and meets the bottom surface 23a and the upper surface 23b perpendicularly.

A side-surface edge portion 26a1, where the meeting surface 26a is coupled to the side surface 21a, is parallel to the Z-axis. An end-surface edge portion 26a2, where the meeting surface 26a is coupled to the end surface 22b, is parallel to the Z-axis. A bottom edge portion 26a3, where the meeting surface 26a is coupled to the bottom surface 23a, is perpendicular to the Z-axis. An upper edge portion 26a4, where the meeting surface 26a is coupled to the upper surface 23b, is perpendicular to the Z-axis.

Where a plane on which the meeting surface 26a lies meets a plane on which the side surface 21a, the end surface 22b, the bottom surface 23a, or the upper surface 23b lies may be deemed to be the edge portions of these surfaces. The side-surface edge portion 26a1, the end-surface edge portion 26a2, the bottom edge portion 26a3, and the upper edge portion 26a4 may be edgy or may be smooth. The distance between the side-surface edge portion 26a1 and the end-surface edge portion 26a2 may be similar to the distance L4 (see FIG. 5A) between the side-surface edge portion 25al and the end-surface edge portion 25a2.

As illustrated in FIG. 4, the notch corresponding to the corner 32b has the meeting surface 26b. The meeting surface 26b is coupled to the side surface 21b, the end surface 22b, the bottom surface 23a, and the upper surface 23b. The meeting surface 26b meets the side surface 21b and the end surface 22b at an obtuse angle and meets the bottom surface 23a and the upper surface 23b perpendicularly.

A side-surface edge portion 26b1, where the meeting surface 26b is coupled to the side surface 21b, is parallel to the Z-axis. An end-surface edge portion 26b2, where the meeting surface 26b is coupled to the end surface 22b, is parallel to the Z-axis. A bottom edge portion 26b3, where the meeting surface 26b is coupled to the bottom surface 23a, is perpendicular to the Z-axis. An upper edge portion 26b4, where the meeting surface 26b is coupled to the upper surface 23b, is perpendicular to the Z-axis.

Where a plane on which the meeting surface 26b lies meets a plane on which the side surface 21b, the end surface 22b, the bottom surface 23a, or the upper surface 23b lies may be deemed to be the edge portions of these surfaces. The side-surface edge portion 26b1, the end-surface edge portion 26b2, the bottom edge portion 26b3, and the upper edge portion 26b4 may be edgy or may be smooth. The distance between the side-surface edge portion 26b1 and the end-surface edge portion 26b2 may be similar to the distance L4 (see FIG. 5A) between the side-surface edge portion 25al and the end-surface edge portion 25a2.

As illustrated in FIGS. 1A and 1B, the exterior body 4 is a member with which the coil 1 and the core 2 are sealed and in which they are accommodated, defining the external shape of the coil device 100. In the present embodiment, the exterior body 4 includes metal particles and a resin (a resin member). Examples of the metal particles include magnetic materials of metals (e.g., iron, cobalt, and nickel) or alloys.

The metal particles included in the exterior body 4 may have any average particle size (D50). The average particle size (D50) is, for example, 1 μm to 50 μm. The metal particles may include two or more types of particles with different average particle sizes (D50). The exterior body 4 can be formed using known methods, such as compaction molding and injection molding. The exterior body 4 may have a lower specific gravity than that of the core 2.

The resin included in the exterior body 4 is not limited. Examples of the resin include thermosetting resins, such as an epoxy resin and a phenol resin. The exterior body 4 may include a filler other than the metal particles. Examples of the filler other than the metal particles include an inorganic filler (e.g., silica) with any particle size. This particle size is, for example, 2 μm to 5 μm. The exterior body 4 may have any relative permeability. The relative permeability is, for example, 1 to 20,000.

As illustrated in FIGS. 1A and 1B, the exterior body 4 covers at least the portions of the core 2 other than the bottom surface 23a and the coil 1. In other words, the portions of the core 2 other than the bottom surface 23a and the coil 1 are disposed in the exterior body 4. Outside the exterior body 4, the bottom surface 23a of the core 2 and the mounting portions 82 and 82 of the terminal electrodes 80a and 80b attached to the bottom surface 23a are exposed.

In the present embodiment, broadly, the exterior body 4 is a hexahedron including six surfaces, namely the first surface 40a to the sixth surface 40f. As illustrated in FIG. 1A or FIG. 1B, the fifth surface 40e of the exterior body 4 is coupled to the first surface 40a at a first ridge portion 60a, is coupled to the second surface 40b at a second ridge portion 60b, is coupled to the third surface 40c at a third ridge portion 60c, and is coupled to the fourth surface 40d at a fourth ridge portion 60d. The sixth surface 40f is coupled to the first surface 40a at a fifth ridge portion 60e, is coupled to the second surface 40b at a sixth ridge portion 60f, is coupled to the third surface 40c at a seventh ridge portion 60g, and is coupled to the fourth surface 40d at an eighth ridge portion 60h.

As illustrated in FIG. 1B, the first surface 40a is coupled to the third surface 40c at a ninth ridge portion 60i and is coupled to the fourth surface 40d at a tenth ridge portion 60j. As illustrated in FIG. 1A, the second surface 40b is coupled to the third surface 40c at an eleventh ridge portion 60k and is coupled to the fourth surface 40d at a twelfth ridge portion 601. In the present embodiment, the first ridge portion 60a to the twelfth ridge portion 601 are smooth, roundish arc-shaped surfaces; however, the first ridge portion 60a to the twelfth ridge portion 601 may be edgy.

As illustrated in FIG. 1A, the exterior body 4 covers the coil 1. As illustrated in FIGS. 2A to 2D, above the protruding end 39 of the core 2 and the winding portion 10 in the Z-axis direction is covered with an upper central portion 57 of the exterior body 4. Outer sides of the winding portion 10 in the direction perpendicular to the Z-axis are covered with outer portions of the exterior body 4. The exterior body 4 is in spaces of the wire constituting the winding portion 10 of the coil 1. In the present specification, side-surface outer portions 41a and 41b, end-surface outer portions 42a and 42b, and ridge outer portions 45a, 45b, 46a, and 46b may simply be referred to as the outer portions unless they have different characteristics.

As illustrated in FIG. 2A, the exterior body 4 includes the side-surface outer portion 41a, which covers one outer side of the winding portion 10 in the X-axis direction. The side-surface outer portion 41a is located above the side surface 21a of the base portion 20 in the Z-axis direction. The side-surface outer portion 41a constitutes the first surface 40a of the exterior body 4. The side-surface outer portion 41a constitutes a region that is outward from an outermost end of the winding portion 10 far from the central axis C and is from the upper surface 23b of the base portion 20 to an uppermost end of the winding portion 10 in the Z-axis direction.

As illustrated in FIG. 2A, the exterior body 4 includes a bottom side-surface portion 47a, which is located below the side-surface outer portion 41a in the Z-axis direction and outward from the side surface 21a of the base portion 20 in the X-axis direction. The bottom side-surface portion 47a constitutes the first surface 40a and the fifth surface 40e of the exterior body 4. In the exterior body 4, the bottom side-surface portion 47a constitutes a region that is outward from the side surface 21a in the X-axis direction and is below the upper surface 23b of the base portion 20. In other words, as illustrated in FIG. 5A, the bottom side-surface portion 47a corresponds to a region surrounded by imaginary planes S drawn along the X-axis from the side-surface edge portions 25a1 and 26a1, the side surface 21a, and the first surface 40a. Note that the side surface 21a may be exposed from the bottom side-surface portion 47a.

As illustrated in FIG. 2A, the exterior body 4 includes an upper side-surface portion 53a, which is located above the side-surface outer portion 41a in the Z-axis direction and outward at one side from the upper central portion 57 in the X-axis direction. The upper side-surface portion 53a constitutes the first surface 40a and the sixth surface 40f of the exterior body 4. In the exterior body 4, the upper side-surface portion 53a constitutes a region that is outward at one side from the winding portion 10 in the X-axis direction and is above the uppermost end of the winding portion 10 in the Z-axis direction.

As illustrated in FIG. 2A, the exterior body 4 includes the side-surface outer portion 41b, which covers an other outer side of the winding portion 10 in the X-axis direction. The side-surface outer portion 41b is located above the side surface 21b of the base portion 20 in the Z-axis direction. The side-surface outer portion 41b constitutes the second surface 40b of the exterior body 4. The side-surface outer portion 41b constitutes a region that is outward from the outermost end of the winding portion 10 far from the central axis C and is from the upper surface 23b of the base portion 20 to the uppermost end of the winding portion 10 in the Z-axis direction.

As illustrated in FIG. 2A, the exterior body 4 includes a bottom side-surface portion 47b, which is located below the side-surface outer portion 41b in the Z-axis direction and outward from the side surface 21b of the base portion 20 in the X-axis direction. The bottom side-surface portion 47b constitutes the second surface 40b and the fifth surface 40e of the exterior body 4. The bottom side-surface portion 47b constitutes a region that is outward from the side surface 21b in the X-axis direction and is below the upper surface 23b of the base portion 20. In other words, as illustrated in FIG. 5A, the bottom side-surface portion 47b corresponds to a region surrounded by imaginary planes S drawn along the X-axis from the side-surface edge portions 25b1 and 26b1, the side surface 21b, and the second surface 40b. Note that the side surface 21b may be exposed from the bottom side-surface portion 47b.

As illustrated in FIG. 2A, the exterior body 4 includes an upper side-surface portion 53b, which is located above the side-surface outer portion 41b in the Z-axis direction and outward at an other side from the upper central portion 57 in the X-axis direction. The upper side-surface portion 53b constitutes the second surface 40b and the sixth surface 40f of the exterior body 4. The upper side-surface portion 53b constitutes a region that is outward at the other side from the winding portion 10 in the X-axis direction and is above the uppermost end of the winding portion 10 in the Z-axis direction.

As illustrated in FIG. 2B, the exterior body 4 includes the end-surface outer portion 42a, which covers one outer side of the winding portion 10 in the Y-axis direction. The end-surface outer portion 42a is located above the end surface 22a of the base portion 20 in the Z-axis direction. The end-surface outer portion 42a constitutes the third surface 40c of the exterior body 4. The end-surface outer portion 42a constitutes a region that is outward from the outermost end of the winding portion 10 far from the central axis C and is from the upper surface 23b of the base portion 20 to the uppermost end of the winding portion 10 in the Z-axis direction.

As illustrated in FIG. 2B, the exterior body 4 includes a bottom end-surface portion 48a, which is located below the end-surface outer portion 42a in the Z-axis direction and outward from the end surface 22a of the base portion 20 in the Y-axis direction. The bottom end-surface portion 48a constitutes the third surface 40c and the fifth surface 40e of the exterior body 4. The bottom end-surface portion 48a constitutes a region that is outward from the end surface 22a in the Y-axis direction and is below the upper surface 23b of the base portion 20. In other words, as illustrated in FIG. 5A, the bottom end-surface portion 48a corresponds to a region surrounded by imaginary planes S drawn along the Y-axis from the end-surface edge portions 25a2 and 25b2, the end surface 22a, and the third surface 40c. Note that the end surface 22a may be exposed from the bottom end-surface portion 48a.

As illustrated in FIG. 2B, the exterior body 4 includes an upper end-surface portion 54a, which is located above the end-surface outer portion 42a in the Z-axis direction and outward at one side from the upper central portion 57 in the Y-axis direction. The upper end-surface portion 54a constitutes the third surface 40c and the sixth surface 40f of the exterior body 4. The upper end-surface portion 54a constitutes a region that is outward at one side from the winding portion 10 in the Y-axis direction and is above the uppermost end of the winding portion 10 in the Z-axis direction.

As illustrated in FIG. 2B, the exterior body 4 includes the end-surface outer portion 42b, which covers an other outer side of the winding portion 10 in the Y-axis direction. The end-surface outer portion 42b is located above the end surface 22b of the base portion 20 in the Z-axis direction. The end-surface outer portion 42b constitutes the fourth surface 40d of the exterior body 4 and constitutes a region that is outward from the outermost end of the winding portion 10 far from the central axis C and is from the upper surface 23b of the base portion 20 to the uppermost end of the winding portion 10 in the Z-axis direction.

As illustrated in FIG. 2B, the exterior body 4 includes a bottom end-surface portion 48b, which is located below the end-surface outer portion 42b in the Z-axis direction and outward from the end surface 22b of the base portion 20 in the Y-axis direction. The bottom end-surface portion 48b constitutes the fourth surface 40d and the fifth surface 40e of the exterior body 4. The bottom end-surface portion 48b constitutes a region that is outward from the end surface 22b in the Y-axis direction and is below the upper surface 23b of the base portion 20. In other words, as illustrated in FIG. 5A, the bottom end-surface portion 48b corresponds to a region surrounded by imaginary planes S drawn along the Y-axis from the end-surface edge portions 26a2 and 26b2, the end surface 22b, and the fourth surface 40d. Note that the end surface 22b may be exposed from the bottom end-surface portion 48b.

As illustrated in FIG. 2B, the exterior body 4 includes an upper end-surface portion 54b, which is located above the end-surface outer portion 42b in the Z-axis direction and outward at an other side from the upper central portion 57 in the Y-axis direction. The upper end-surface portion 54b constitutes the fourth surface 40d and the sixth surface 40f of the exterior body 4. The upper end-surface portion 54b constitutes a region that is outward at the other side from the winding portion 10 in the Y-axis direction and is above the uppermost end of the winding portion 10 in the Z-axis direction.

As illustrated in FIG. 2C, the exterior body 4 includes the ridge outer portion 45a. The ridge outer portion 45a includes the ninth ridge portion 60i and constitutes the first surface 40a and the third surface 40c (see FIG. 1A). In the exterior body 4, the ridge outer portion 45a constitutes a region that is outward from the outermost end of the winding portion 10 far from the central axis C and is from the upper surface 23b of the base portion 20 to the uppermost end of the winding portion 10 in the Z-axis direction. The ridge outer portion 45a covers an outer side of the winding portion 10 in the direction perpendicular to the Z-axis and the lead-out portion 11a.

As illustrated in FIG. 2C, the exterior body 4 includes a bottom corner portion 51a. The bottom corner portion 51a includes the ninth ridge portion 60i and constitutes the first surface 40a, the third surface 40c (see FIG. 1A), and the fifth surface 40e. The bottom corner portion 51a is located below the ridge outer portion 45a. In the exterior body 4, the bottom corner portion 51a constitutes a region that is below the upper surface 23b of the base portion 20 and is outward from the meeting surface 25a.

In other words, as illustrated in FIG. 5A, the bottom corner portion 51a corresponds to a region surrounded by the imaginary plane S drawn along the X-axis from the side-surface edge portion 25a1, the imaginary plane S drawn along the Y-axis from the end-surface edge portion 25a2, the meeting surface 25a, the first surface 40a, the third surface 40c, and the ninth ridge portion 60i. The bottom corner portion 51a covers the meeting surface 25a of the notch, the wire connecting portion 84 of the terminal electrode 80a, and the lead-out portion 11a.

As illustrated in FIG. 2C, the exterior body 4 includes an upper corner portion 55a. The upper corner portion 55a includes the ninth ridge portion 60i and constitutes the first surface 40a, the third surface 40c (see FIG. 1A), and the sixth surface 40f. The upper corner portion 55a is located above the ridge outer portion 45a. In the exterior body 4, the upper corner portion 55a constitutes a region that is outward from the winding portion 10 and is above the uppermost end of the winding portion 10 in the Z-axis direction.

As illustrated in FIG. 2C, the exterior body 4 includes the ridge outer portion 46b. The ridge outer portion 46b includes the twelfth ridge portion 601 and constitutes the second surface 40b and the fourth surface 40d (see FIG. 1A). In the exterior body 4, the ridge outer portion 46b constitutes a region that is outward from the outermost end of the winding portion 10 far from the central axis C and is from the upper surface 23b of the base portion 20 to the uppermost end of the winding portion 10 in the Z-axis direction. The ridge outer portion 46b covers an outer side of the winding portion 10 in the direction perpendicular to the Z-axis.

As illustrated in FIG. 2C, the exterior body 4 includes a bottom corner portion 52b. The bottom corner portion 52b includes the twelfth ridge portion 601 and constitutes the second surface 40b (see FIG. 1A), the fourth surface 40d (see FIG. 1A), and the fifth surface 40e. The bottom corner portion 52b is located below the ridge outer portion 46b. In the exterior body 4, the bottom corner portion 52b constitutes a region that is below the upper surface 23b of the base portion 20 and is outward from the meeting surface 26b.

In other words, as illustrated in FIG. 5A, the bottom corner portion 52b corresponds to a region surrounded by the imaginary plane S drawn along the X-axis from the side-surface edge portion 26b1, the imaginary plane S drawn along the Y-axis from the end-surface edge portion 26b2, the meeting surface 26b, the second surface 40b, the fourth surface 40d, and the twelfth ridge portion 601. The bottom corner portion 52b covers the meeting surface 26b of the notch and the dummy wire connecting portion 86 of the terminal electrode 80b.

As illustrated in FIG. 2C, the exterior body 4 includes an upper corner portion 56b. The upper corner portion 56b includes the twelfth ridge portion 601 and constitutes the second surface 40b (see FIG. 1A), the fourth surface 40d (see FIG. 1A), and the sixth surface 40f. The upper corner portion 56b is located above the ridge outer portion 46b. In the exterior body 4, the upper corner portion 56b constitutes a region that is outward from the winding portion 10 and is above the uppermost end of the winding portion 10 in the Z-axis direction.

As illustrated in FIG. 2D, the exterior body 4 includes the ridge outer portion 45b. The ridge outer portion 45b includes the eleventh ridge portion 60k and constitutes the second surface 40b and the third surface 40c (see FIG. 1A). In the exterior body 4, the ridge outer portion 45b constitutes a region that is outward from the outermost end of the winding portion 10 far from the central axis C and is from the upper surface 23b of the base portion 20 to the uppermost end of the winding portion 10 in the Z-axis direction. The ridge outer portion 45b covers an outer side of the winding portion 10 in the direction perpendicular to the Z-axis and the lead-out portion 11b.

As illustrated in FIG. 2D, the exterior body 4 includes a bottom corner portion 51b. The bottom corner portion 51b includes the eleventh ridge portion 60k and constitutes the second surface 40b (see FIG. 1A), the third surface 40c (see FIG. 1A), and the fifth surface 40e. The bottom corner portion 51b is located below the ridge outer portion 45b. In the exterior body 4, the bottom corner portion 51b constitutes a region that is below the upper surface 23b of the base portion 20 and is outward from the meeting surface 25b.

In other words, as illustrated in FIG. 5A, the bottom corner portion 51b corresponds to a region surrounded by the imaginary plane S drawn along the X-axis from the side-surface edge portion 25b1, the imaginary plane S drawn along the Y-axis from the end-surface edge portion 25b2, the meeting surface 25b, the second surface 40b, the third surface 40c, and the eleventh ridge portion 60k. The bottom corner portion 51b covers the meeting surface 25b of the notch, the wire connecting portion 84 of the terminal electrode 80b, and the lead-out portion 11b.

As illustrated in FIG. 2D, the exterior body 4 includes an upper corner portion 55b. The upper corner portion 55b includes the eleventh ridge portion 60k and constitutes the second surface 40b (see FIG. 1A), the third surface 40c (see FIG. 1A), and the sixth surface 40f. The upper corner portion 55b is located above the ridge outer portion 45b. In the exterior body 4, the upper corner portion 55b constitutes a region that is outward from the winding portion 10 and is above the uppermost end of the winding portion 10 in the Z-axis direction.

As illustrated in FIG. 2D, the exterior body 4 includes the ridge outer portion 46a. The ridge outer portion 46a includes the tenth ridge portion 60j and constitutes the first surface 40a and the fourth surface 40d (see FIG. 1A). In the exterior body 4, the ridge outer portion 46a constitutes a region that is outward from the outermost end of the winding portion 10 far from the central axis C and is from the upper surface 23b of the base portion 20 to the uppermost end of the winding portion 10 in the Z-axis direction. The ridge outer portion 46a covers an outer side of the winding portion 10 in the direction perpendicular to the Z-axis.

As illustrated in FIG. 2D, the exterior body 4 includes a bottom corner portion 52a. The bottom corner portion 52a includes the tenth ridge portion 60j and constitutes the first surface 40a (see FIG. 1A), the fourth surface 40d (see FIG. 1A), and the fifth surface 40e. The bottom corner portion 52a is located below the ridge outer portion 46a. In the exterior body 4, the bottom corner portion 52a constitutes a region that is below the upper surface 23b of the base portion 20 and is outward from the meeting surface 26a.

In other words, as illustrated in FIG. 5A, the bottom corner portion 52a corresponds to a region surrounded by the imaginary plane S drawn along the X-axis from the side-surface edge portion 26a1, the imaginary plane S drawn along the Y-axis from the end-surface edge portion 26a2, the meeting surface 26a, the first surface 40a, the fourth surface 40d, and the tenth ridge portion 60j. The bottom corner portion 52a covers the meeting surface 26a of the notch and the dummy wire connecting portion 86 of the terminal electrode 80a.

As illustrated in FIG. 2D, the exterior body 4 includes an upper corner portion 56a. The upper corner portion 56a includes the tenth ridge portion 60j and constitutes the first surface 40a (see FIG. 1A), the fourth surface 40d (see FIG. 1A), and the sixth surface 40f. The upper corner portion 56a is located above the ridge outer portion 46a. In the exterior body 4, the upper corner portion 56a constitutes a region that is outward from the winding portion 10 and is above the uppermost end of the winding portion 10 in the Z-axis direction.

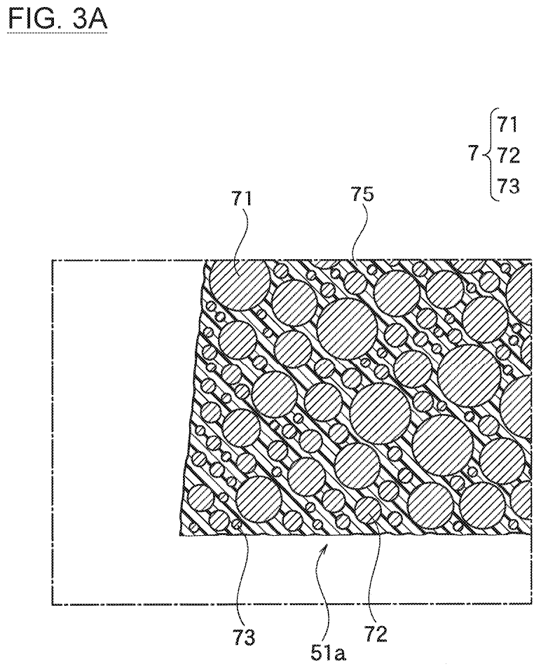

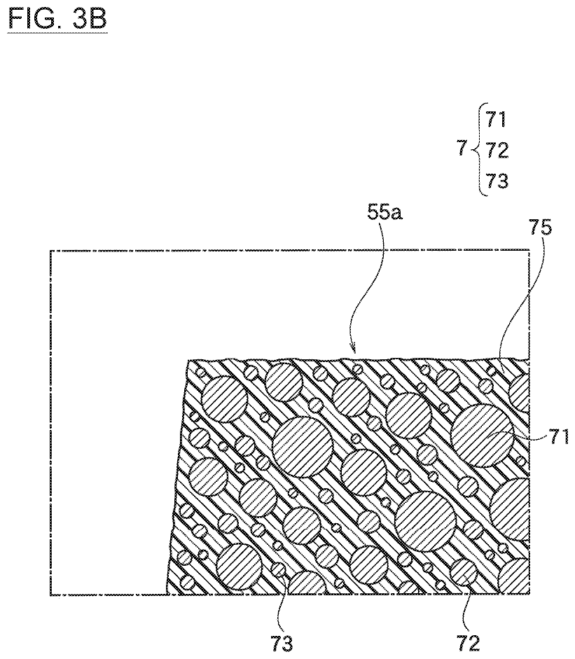

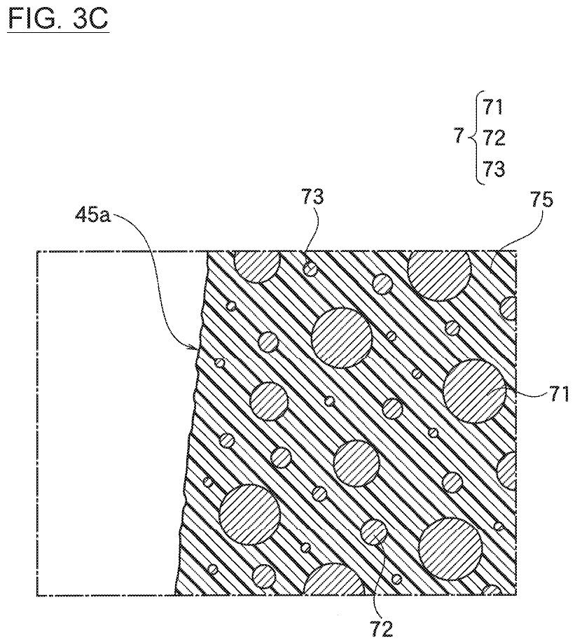

As illustrated in FIGS. 3A to 3C, the exterior body 4 includes metal particles 7 and a resin 75. The metal particles 7 include particles with different average particle sizes (D50). The metal particles 7 include first particles 71 with a largest average particle size (D50) and small particles with a smaller average particle size (D50) than that of the first particles 71. The small particles may further include particles with different average particle sizes (D50). In the present embodiment, second particles 72 and third particles 73 correspond to the small particles and have a smaller average particle size (D50) than that of the first particles 71. In the present embodiment, the third particles 73 have a smaller average particle size (D50) than that of the second particles 72.

With reference to FIGS. 3A to 3C, the metal particles 7 in the bottom corner portion 51a, the upper corner portion 55a, and the ridge outer portion 45a are described below. Description of the bottom corner portion 51a applies to the bottom corner portions 51b, 52a, and 52b unless they have different characteristics. Likewise, description of the upper corner portion 55a applies to the upper corner portions 55b, 56a, and 56b unless they have different characteristics. Likewise, description of the ridge outer portion 45a applies to the ridge outer portions 45b, 46a, and 46b.

The metal particles 7 occupying the bottom corner portion 51a, the upper corner portion 55a, and the ridge outer portion 45a illustrated in FIGS. 3A to 3C may constitute any structures. The small particles (the second particles 72 and the third particles 73) occupying the bottom corner portion 51a account for, for example, a larger volume fraction than that of the small particles (the second particles 72 and the third particles 73) occupying the upper corner portion 55a; and the small particles (the second particles 72 and the third particles 73) occupying the upper corner portion 55a account for, for example, a larger volume fraction than that of the small particles (the second particles 72 and the third particles 73) occupying the ridge outer portion. Such structures can effectively prevent the exterior body 4 from falling off.

As illustrated in FIGS. 3A and 3B, the metal particles 7 occupying the bottom corner portion 51a account for a volume fraction equivalent to or larger than that of the metal particles 7 occupying the upper corner portion 55a. In terms of improving magnetic characteristics of the coil device 100 and preventing the exterior body 4 from falling off, preferred is a high volume fraction of the metal particles 7 occupying the bottom corner portion 51a. However, provided that the volume fraction of the metal particles 7 occupying the bottom corner portion 51a is one or more times the volume fraction of the metal particles 7 occupying the upper corner portion 55a, the volume fraction of the metal particles 7 occupying the bottom corner portion 51 a may be, for example, 1.1 or more times, 1.3 or more times, or 1.5 or more times the volume fraction of the metal particles 7 occupying the upper corner portion 55a.

The relation between the volume fraction of the metal particles 7 occupying the bottom corner portion 51b, 52a, or 52b and the volume fraction of the metal particles 7 occupying the upper corner portion 55b, 56a, or 56b located above the corresponding bottom corner portion in the Z-axis direction is similar to the relation between the volume fraction of the metal particles 7 occupying the bottom corner portion 51a and the volume fraction of the metal particles 7 occupying the upper corner portion 55a.

Although the volume fraction of the metal particles 7 occupying the bottom corner portion 51a is not limited, this volume fraction is, for example, larger than the volume fraction of the metal particles 7 occupying the ridge outer portion 45a, as illustrated in FIGS. 3A and 3C. The volume fraction of the metal particles 7 occupying the bottom corner portion 51 a may be 1.1 or more times, 1.3 or more times, or 1.5 or more times the volume fraction of the metal particles 7 occupying the ridge outer portion 45a.

The relation between the volume fraction of the metal particles 7 occupying the bottom corner portion 51b, 52a, or 52b and the volume fraction of the metal particles 7 occupying the ridge outer portion 45b, 46a, or 46b located above the corresponding bottom corner portion in the Z-axis direction is similar to the relation between the volume fraction of the metal particles 7 occupying the bottom corner portion 51a and the volume fraction of the metal particles 7 occupying the ridge outer portion 45a.

As illustrated in FIGS. 3B and 3C, the volume fraction of the metal particles 7 occupying the upper corner portion 55a is not limited. In terms of improving magnetic characteristics of the coil device 100 and preventing the exterior body 4 from falling off, preferred is that the volume fraction of the metal particles 7 occupying the upper corner portion 55a is equivalent to or larger than the volume fraction of the metal particles 7 occupying the ridge outer portion 45a.

The relation between the volume fraction of the metal particles 7 occupying the upper corner portion 55b, 56a, or 56b and the volume fraction of the metal particles 7 occupying the ridge outer portion 45b, 46a, or 46b located below the corresponding upper corner portion in the Z-axis direction is similar to the relation between the volume fraction of the metal particles 7 occupying the upper corner portion 55a and the volume fraction of the metal particles 7 occupying the ridge outer portion 45a.

The relation between the volume fraction of the metal particles 7 occupying the bottom corner portion 51a, 51b, 52a, or 52b and the volume fraction of the metal particles 7 occupying the side-surface outer portion 41a or 41b and the end-surface outer portion 42a or 42b is not limited. A larger volume fraction of the metal particles 7 occupying the bottom corner portion 51a, 51b, 52a, or 52b than the volume fraction of the metal particles 7 occupying the side-surface outer portion 41a or 41b and the end-surface outer portion 42a or 42b can effectively prevent the exterior body 4 from falling off from the bottom corner portion 51a, 51b, 52a, or 52b.

In the exterior body 4, the metal particles 7 occupying the portions located below the upper surface 23b of the base portion 20 account for a volume fraction equivalent to or larger than that of the metal particles 7 occupying the portions located above the upper surface 23b of the base portion 20. The volume fraction of the metal particles 7 occupying the bottom side-surface portion 47a or 47b, the bottom end-surface portion 48a or 48b, and the bottom corner portion 51a, 51b, 52a, or 52b is equivalent to or larger than the volume fraction of the metal particles 7 occupying the other portions, namely the side-surface outer portion 41a or 41b, the end-surface outer portion 42a or 42b, the ridge outer portion 45a, 45b, 46a, or 46b, the upper side-surface portion 53a or 53b, the upper end-surface portion 54a or 54b, the upper corner portion 55a, 55b, 56a, or 56b, and the upper central portion 57.

The volume fraction of the metal particles 7 occupying the bottom corner portion 51a, 51b, 52a, or 52b may be equivalent to the volume fraction of the metal particles 7 occupying the bottom side-surface portion 47a or 47b and the bottom end-surface portion 48a or 48b. Note that, even if the volume fraction of the metal particles 7 occupying the bottom corner portion 51a, 51b, 52a, or 52b is smaller than the volume fraction of the metal particles 7 occupying the bottom side-surface portion 47a or 47b and the bottom end-surface portion 48a or 48b, the exterior body 4 can sufficiently be prevented from falling off.

The relation between the volume fraction of the metal particles 7 occupying the side-surface outer portion 41a or 41b and the end-surface outer portion 42a or 42b and the volume fraction of the metal particles 7 occupying the ridge outer portion 45a, 45b, 46a, or 46b is not limited. The volume fraction of the metal particles 7 occupying the ridge outer portion 45a, 45b, 46a, or 46b being equivalent to or larger than the volume fraction of the metal particles 7 occupying the side-surface outer portion 41a or 41b and the end-surface outer portion 42a or 42b can effectively prevent the exterior body 4 from falling off from the ridge outer portion 45a, 45b, 46a, or 46b.

The relation between the volume fraction of the metal particles 7 occupying the upper central portion 57 and the volume fraction of the metal particles 7 occupying the upper corner portion 55a, 55b, 56a, or 56b is not limited. A larger volume fraction of the metal particles 7 occupying the upper corner portion 55a, 55b, 56a, or 56b than the volume fraction of the metal particles 7 occupying the upper central portion 57 can effectively prevent the exterior body 4 from falling off from the upper corner portion 55a, 55b, 56a, or 56b.

The above volume fraction of the metal particles 7 occupying each portion of the exterior body 4 can be assumed to be measured, for example, as follows. A sectional image of each portion is captured using a scanning electron microscope (SEM). The area of that portion and the sectional area of the metal particles 7 occupying that portion are measured. The area of that portion is converted into the volume of that portion. The sectional area of the metal particles 7 occupying that portion is converted into the volume of the metal particles 7. In this manner, the volume fraction of the metal particles 7 occupying each portion of the exterior body 4 can be measured.

Methods of manufacturing the coil device 100 according to the present embodiment are not limited. The coil device 100 can be manufactured, for example, as follows.

First, the coil 1 including the winding portion 10 is prepared. Also, the core 2 (sintered body) including the core central portion 38 and the base portion 20 illustrated in FIG. 4 is prepared. To the base portion 20 of the core 2 (sintered body), conductive paste films are applied to form the terminal electrodes 80a and 80b.

Then, the coil 1 is attached to the core 2. Then, the lead-out portion 11a is thermocompression bonded to the terminal electrode 80a, and the lead-out portion 11b is thermocompression bonded to the terminal electrode 80b.

Then, the assembly including the coil 1 and the core 2 is disposed in a cavity of a predetermined mold. Around this assembly, an exterior material that forms the exterior body 4 is insert injection molded. This can manufacture the coil device 100. As the exterior material that forms the exterior body 4, a material having fluidity at the time of molding is used. A complex magnetic material including the metal particles 7 and the resin 75 as a binder may be used.

As described above, in the coil device 100 according to the present embodiment, the corners 31a, 31b, 32a, and 32b (see FIG. 4) of the base portion 20 of the core 2 are notched. Thus, a manufacturing defect such that the corners of the base portion 20 become exposed from the exterior body 4 does not occur. The meeting surfaces 25a, 25b, 26a, and 26b, which correspond to the notches, are covered with the bottom corner portions 51a, 51b, 52a, and 52b of the exterior body 4. Because the corners 31a, 31b, 32a, and 32b are satisfactorily filled with the bottom corner portions 51a, 51b, 52a, and 52b while the exterior body 4 is formed with the above exterior material, a filling defect does not easily occur.

The metal particles 7 included in the bottom corner portions 51a, 51b, 52a, and 52b have a high filling density. Thus, the exterior body does not easily fall off from the bottom corner portions 51a, 51b, 52a, and 52b and the upper corner portions 55a, 55b, 56a, and 56b of the exterior body 4 as starting points. A larger volume fraction of the metal particles 7 occupying the bottom corner portions 51a, 51b, 52a, and 52b of the exterior body 4 than the volume fraction of the metal particles 7 occupying the outer portions, which cover the outer sides of the winding portion 10, further improves the strength of the bottom corner portions 51a, 51b, 52a, and 52b.

The bottom surface 23a of the base portion 20 has an external shape that is similar to that of the exterior body 4 in plan view but is notched at the corners 31a, 31b, 32a, and 32b. The base portion 20 with such an external shape is easily molded with the exterior body 4. This can reduce manufacturing costs.

The core 2 is a sintered body of a metal magnetic body. Such a core can improve characteristics of the coil device 100. By including the core central portion 38, which protrudes upward from the base portion 20, the core 2 can have its core central portion disposed in the winding portion 10 of the coil 1. Thus, the coil 1 and the core 2 are easily assembled during manufacture of the coil device 100 as described above. This makes it difficult for a manufacturing defect to occur.

To the base portion 20, the terminal electrodes 80a and 80b are attached. To the wire connecting portions 84 and 84 of the terminal electrodes 80a and 80b, the lead-out portions 11a and 11b are connected. The wire connecting portions 84 and 84 of the terminal electrodes 80a and 80b are, together with the lead-out portions 11a and 11b, covered with the exterior body 4. Thus, in the coil device 100, disconnection at the wire connecting portions 84 and 84 does not easily occur.

The wire connecting portions of the terminal electrodes 80a and 80b are disposed in the notches of the base portion 20 and are covered, together with the lead-out portions 11a and 11b, with the bottom corner portions 51a, 51b, 52a, and 52b of the exterior body 4. The bottom corner portions 51a, 51b, 52a, and 52b are highly filled with the metal particles 7. Such bottom corner portions 51a, 51b, 52a, and 52b protect the lead-out portions 11a and 11b as well as the wire connecting portions 84 and 84. This further improves the product strength.

The notches have the meeting surfaces 25a, 25b, 26a, and 26b, which substantially perpendicularly meet the bottom surface 23a of the base portion 20. Such a structure enables the bottom corner portions 51a, 51b, 52a, and 52b to be easily filled with the metal particles 7, increasing the volume fraction of the metal particles occupying the bottom corner portions 51a, 51b, 52a, and 52b.

The terminal electrodes 80a and 80b include the mounting portions 82 and 82, which are disposed at the bottom surface 23a of the base portion 20. Thus, the coil device 100 can be suitably used as a surface-mounting coil device with the fifth surface 100e as a mounting surface.

In the present embodiment, the metal particles 7 included in the exterior body 4 include the first particles 71, the second particles 72, and third particles 73 with different average particle sizes (D50). Thus, the metal particles 7 more easily fill each portion. This can improve characteristics and the product strength of the coil device 100.

### Second Embodiment

A coil device 200 according to the present embodiment has a structure of a base portion 20a of a core different from the structure of the base portion 20 of the core of the coil device 100 of the first embodiment but has other structures in common, exhibiting effects similar to those of the coil device 100 of the first embodiment. Hereinafter, what is common to the first and second embodiments is omitted from being described as much as possible and is given the same reference numeral as in the first embodiment to the extent necessary.

As illustrated in FIG. 5B, a bottom surface 23a of the base portion 20a of the core has an external shape that is similar to that of an exterior body 4 in plan view but is notched at corners 31a, 31b, 32a, and 32b. Meeting surfaces 25a, 25b, 26a, and 26b, which are at the portions corresponding to the corners 31a, 31b, 32a, and 32b, are larger than the meeting surfaces 25a, 25b, 26a, and 26b of the first embodiment. The bottom surface 23a has a rhombic shape.

In detail, as illustrated in FIG. 5B, a side-surface edge portion 25a1 of the meeting surface 25a and a side-surface edge portion 26a1 of the meeting surface 26a overlap. In other words, a side surface 21a is integrated with the side-surface edge portions 25a1 and 26a1.

As illustrated in FIG. 5B, a side-surface edge portion 25b1 of the meeting surface 25b and a side-surface edge portion 26b1 of the meeting surface 26b overlap. In other words, a side surface 21b is integrated with the side-surface edge portions 25b1 and 26b1.

As illustrated in FIG. 5B, an end-surface edge portion 25a2 of the meeting surface 25a and an end-surface edge portion 25b2 of the meeting surface 25b overlap. In other words, an end surface 22a is integrated with the end-surface edge portions 25a2 and 25b2.

As illustrated in FIG. 5B, an end-surface edge portion 26a2 of the meeting surface 26a and an end-surface edge portion 26b2 of the meeting surface 26b overlap. In other words, an end surface 22b is integrated with the end-surface edge portions 26a2 and 26b2.

Such a structure makes it difficult for the base portion 20a of the core of the coil device 200 to become exposed from the exterior body 4. This makes it more difficult for a manufacturing defect to occur.

### Third Embodiment

A coil device 300 according to the present embodiment has a structure of a base portion 20b of a core different from the structure of the base portion 20 of the core of the coil device 100 of the first embodiment but has other structures in common, exhibiting effects similar to those of the coil device 100 of the first embodiment. Hereinafter, what is common to the first and third embodiments is omitted from being described as much as possible and is given the same reference numeral as in the first embodiment to the extent necessary.

As illustrated in FIG. 5C, a bottom surface 23a of the base portion 20b of the core has an external shape that is similar to that of an exterior body 4 in plan view but is notched at corners 31a, 31b, 32a, and 32b. Meeting surfaces 25a, 25b, 26a, and 26b, which are at the portions corresponding to the corners 31a, 31b, 32a, and 32b, are arc-shaped surfaces that are concave toward a central axis C (see FIG. 2A).

Such a structure enables the base portion 20b of the coil device 300 to have a sufficient volume while certainly preventing the corners of the base portion 20b from being exposed from the exterior body 4.

### Fourth Embodiment

A coil device 400 according to the present embodiment has a structure of a base portion 20c of a core different from the structure of the base portion 20 of the core of the coil device 100 of the first embodiment but has other structures in common, exhibiting effects similar to those of the coil device 100 of the first embodiment. Hereinafter, what is common to the first and fourth embodiments is omitted from being described as much as possible and is given the same reference numeral as in the first embodiment to the extent necessary.

As illustrated in FIG. 5D, a bottom surface 23a of the base portion 20c of the core has an external shape that is similar to that of an exterior body 4 in plan view but is notched at corners 31a, 31b, 32a, and 32b. In the present embodiment, the corners 31a, 31b, 32a, and 32b are notched rectangularly.

Two meeting surfaces 25a and 25a are provided at the portion corresponding to the corner 31a. One meeting surface 25a is provided along the X-axis whereas the other meeting surface 25a is provided along the Y-axis.

Two meeting surfaces 25b and 25b are provided at the portion corresponding to the corner 31b. One meeting surface 25b is provided along the X-axis whereas the other meeting surface 25b is provided along the Y-axis.

Two meeting surfaces 26a and 26a are provided at the portion corresponding to the corner 32a. One meeting surface 26a is provided along the X-axis whereas the other meeting surface 26a is provided along the Y-axis.

Two meeting surfaces 26b and 26b are provided at the portion corresponding to the corner 32b. One meeting surface 26b is provided along the X-axis whereas the other meeting surface 26b is provided along the Y-axis.

Such a structure enables the base portion 20c of the coil device 400 to have a sufficient volume while certainly preventing the corners of the base portion 20c from being exposed from the exterior body 4.

The present invention is not construed as limited to the above embodiments and can be variously modified within the scope of the present invention. Also, the structures of the embodiments may be appropriately recombined.

Also, although the bottom surface 23a of the base portion 20, 20a, 20b, or 20c of the above embodiments is exposed from the exterior body 4, the exterior body 4 may partly cover the bottom surface 23a.

As is understood from the above description, the present specification discloses the following.

### Additional Note 1

A coil device including:
a coil;
a core including a base portion, the coil being placed on the base portion; and
an exterior body covering the coil and at least an upper part of the base portion, the upper part being above a bottom surface of the base portion,
wherein
the exterior body includes metal particles,
the base portion has a notch at a corner,
the exterior body includes a bottom corner portion covering the notch and an upper corner portion located above the notch, and
the metal particles occupying the bottom corner portion account for a volume fraction not smaller than that of the metal particles occupying the upper corner portion.

### Additional Note 2

The coil device according to Additional Note 1, wherein
the coil includes a winding portion placed on an upper surface of the base portion,
the exterior body includes an outer portion covering an outer side of the winding portion, and
the metal particles occupying the bottom corner portion of the exterior body account for a larger volume fraction than that of the metal particles occupying the outer portion of the exterior body.

### Additional Note 3

The coil device according to Additional Note 2, wherein
the core includes a core central portion protruding upward from the base portion, and
the core central portion is disposed in the winding portion.

### Additional Note 4

The coil device according to Additional Note 2 or 3, wherein
the coil includes a lead-out portion led out from the winding portion,
the lead-out portion is connected to a wire connecting portion of a terminal electrode attached to the base portion, and
the wire connecting portion and the lead-out portion are covered with the exterior body.

### Additional Note 5

The coil device according to Additional Note 4, wherein the wire connecting portion is disposed in the notch.

### Additional Note 6

The coil device according to Additional Note 4 or 5, wherein the terminal electrode includes a mounting portion disposed at the bottom surface of the base portion.

### additional Note 7

The coil device according to any one of Additional Notes 1 to 6, wherein the notch has a meeting surface substantially perpendicularly meeting the bottom surface of the base portion.

### Additional Note 8

The coil device according to any one of Additional Notes 1 to 7, wherein the metal particles included in the exterior body include first particles with a largest average particle size and small particles with a smaller average particle size than that of the first particles.

### Additional Note 9

The coil device according to Additional Note 8, wherein the small particles occupying the bottom corner portion of the exterior body account for a larger volume fraction than that of the small particles occupying the upper corner portion of the exterior body.

### Additional Note 10

The coil device according to Additional Note 8 or 9, wherein
an outer portion of the exterior body includes a ridge outer portion located between the bottom corner portion and the upper corner portion, and
the small particles occupying the upper corner portion account for a larger volume fraction than that of the small particles occupying the ridge outer portion.

### Additional Note 11

The coil device according to any one of Additional Notes 1 to 10, wherein the core includes a sintered body of a metal magnetic body.

### Additional Note 12

The coil device according to any one of Additional Notes 1 to 11, wherein the bottom surface of the base portion has an external shape that is similar to that of the exterior body in plan view but is notched at the corner.

### DESCRIPTION OF THE REFERENCE NUMERICAL

100, 200, 300, 400 . . . coil device
100a to 100f . . . first surface to sixth surface
1 . . . coil
10 . . . winding portion
11a, 11b . . . lead-out portion
2 . . . core (element body)
20, 20a, 20b, 20c . . . base portion
21a, 21b . . . side surface
22a, 22b . . . end surface
23a . . . bottom surface
23b . . . upper surface
25a, 25b, 26a, 26b . . . meeting surface (notch)
25a1, 25b1, 26a1, 26b1 . . . side-surface edge portion
25a2, 25b2, 26a2, 26b2 . . . end-surface edge portion
25a3, 25b3, 26a3, 26b3 . . . bottom edge portion
25a4, 25b4, 26a4, 26b4 . . . upper edge portion
31a, 31b, 32a, 32b . . . corner
38 . . . core central portion
39 . . . protruding end
4 . . . exterior body (element body)
40a to 40f . . . first surface to sixth surface
41a, 41b . . . side-surface outer portion
42a, 42b . . . end-surface outer portion
45a, 45b, 46a, 46b . . . ridge outer portion
47a, 47b . . . bottom side-surface portion
48a, 48b . . . bottom end-surface portion
51a, 51b, 52a, 52b . . . bottom corner portion
53a, 53b . . . upper side-surface portion
54a, 54b . . . upper end-surface portion
55a, 55b, 56a, 56b . . . upper corner portion
57 . . . upper central portion
60a to 601 . . . first ridge portion to twelfth ridge portion
7 . . . metal particle
71 . . . first particle
72 . . . second particle
73 . . . third particle
75 . . . resin
80a, 80b . . . terminal electrode
82 . . . mounting portion
84 . . . wire connecting portion
86 . . . dummy wire connecting portion

What is claimed is:

1. A coil device comprising:
a coil;
a core comprising a base portion, the coil being placed on the base portion; and
an exterior body covering the coil and at least an upper part of the base portion, the upper part being above a bottom surface of the base portion,
wherein
the exterior body comprises metal particles,
the base portion has a notch at a corner,
the exterior body comprises a bottom corner portion covering the notch and an upper corner portion located above the notch, and
the metal particles occupying the bottom corner portion account for a volume fraction not smaller than that of the metal particles occupying the upper corner portion.

2. The coil device according to claim 1, wherein
the coil comprises a winding portion placed on an upper surface of the base portion,
the exterior body comprises an outer portion covering an outer side of the winding portion, and
the metal particles occupying the bottom corner portion of the exterior body account for a larger volume fraction than that of the metal particles occupying the outer portion of the exterior body.

3. The coil device according to claim 2, wherein
the core comprises a core central portion protruding upward from the base portion, and
the core central portion is disposed in the winding portion.

4. The coil device according to claim 2, wherein
the coil comprises a lead-out portion led out from the winding portion,
the lead-out portion is connected to a wire connecting portion of a terminal electrode attached to the base portion, and
the wire connecting portion and the lead-out portion are covered with the exterior body.

5. The coil device according to claim 4, wherein the wire connecting portion is disposed in the notch.

6. The coil device according to claim 4, wherein the terminal electrode comprises a mounting portion disposed at the bottom surface of the base portion.

7. The coil device according to claim 1, wherein the notch has a meeting surface substantially perpendicularly meeting the bottom surface of the base portion.

8. The coil device according to claim 1, wherein the metal particles included in the exterior body comprise first particles with a largest average particle size and small particles with a smaller average particle size than that of the first particles.

9. The coil device according to claim 8, wherein the small particles occupying the bottom corner portion of the exterior body account for a larger volume fraction than that of the small particles occupying the upper corner portion of the exterior body.

10. The coil device according to claim 8, wherein
an outer portion of the exterior body comprises a ridge outer portion located between the bottom corner portion and the upper corner portion, and
the small particles occupying the upper corner portion account for a larger volume fraction than that of the small particles occupying the ridge outer portion.

11. The coil device according to claim 1, wherein the core comprises a sintered body of a metal magnetic body.

12. The coil device according to claim 1, wherein the bottom surface of the base portion has an external shape that is similar to that of the exterior body in plan view but is notched at the corner.
